(19) United States
(12) Patent Application Publication
(10) Pub. No.: US 2005/0178260 A1
(43) Pub. Date: Aug. 18, 2005

(54) Saw guide system

(76) Inventors: Willibrordus G. Bokelaar, Prince George, VA (US); Simeon B. Hall, Hope Mills, NC (US)

Correspondence Address: JOHN H. THOMAS, P.C., 536 GRANITE AVENUE, RICHMOND, VA, 23226, US

(21) Appl. No.: 10/779,453

(22) Filed: Feb. 13, 2004

(51) Int. Cl. B23D 45/02

(52) U.S. Cl. 83/486.1; 83/574

(57) ABSTRACT

A portable and adaptable cutting table and saw assembly simplify the cutting of long and straight lines. The cutting table includes a tube that is hingedly connected to a frame. The tube has a longitudinal slot in it. A saw guide post is adapted to be slidably received in the slot. A saw assembly includes a nut that is rigidly attached to the saw assembly and that is adapted to receive the saw guide post.

The field of the invention is cutting systems including a saw guide assembly and a saw. The saw guide assembly may include a cutting table having a tube with a slot and a guide post adapted to be slidably received within the slot. The guide post releasably connects to and guides a saw across a work piece.

### BACKGROUND

Many different cutting tables and saw guide systems are adapted to hold a work piece in relation to different types of saws. While existing assemblies are acceptable for small/narrow work pieces, it is difficult to guide straight lines when cutting a wider work piece such as a sheet of plywood. These work pieces are too wide for most conventional tables.

Some cutting assemblies are especially designed to cut wide pieces such as sheets of plywood. Unfortunately, these systems are typically bulky and complicated. They are often too heavy to take to a work site. There is no simple answer for cutting wide pieces such as sheets of plywood at a wood site.

Existing cutting systems may also include complicated connections between a saw and a work table. Typically, the system may require a carpenter to take some time to install the saw into the system before cutting. In some systems, a dedicated saw is required so that a carpenter is not able to use that particular saw for general purposes otherwise.

### SUMMARY

Accordingly, it is an object of the present invention to provide a saw guide system that overcomes the foregoing problems and provides a manageable cutting table and saw that interact to facilitate straight cutting.

In one alternative, a saw guide system comprises a cutting table assembly and a saw assembly. The cutting table assembly comprises a tube that is hingedly connected to a frame, wherein the tube comprises a longitudinal slot therein. The cutting table assembly further comprises a saw guide post that is adapted to be slidably received in the slot. The saw assembly comprises a nut rigidly attached to the saw assembly, the nut adapted to receive the saw guide post. Additionally, the saw assembly may comprise a circular saw. The cutting table may define a substantially planar work surface adapted to support a work piece thereon. The tube may be hingedly connected on one end to the cutting table with the tube being adapted to rotate substantially 180° and substantially parallel to the planar work surface. The slot may have a T-shaped cross-section. The portion of the slot within the tube may have a greater cross-sectional width than the width of the slot at the outside edge of the tube. The tube may have a generally circular or rectangular outside diameter and cross-section. The tube may be supported by mounts that movably secure the tube in relation to the table assembly, and that further allow the tube to rotate in place, thereby rotating the orientation of the slot. The guide post may comprise a foot portion and vertical portion, wherein the foot portion has a cross-section that substantially corresponds to the cross-section of the slot, and the vertical portion has a length that extends out of the slot. The vertical portion of the guide post may have a rectangular horizontal cross-section, and the nut may comprise a rectangular aperture substantially corresponding to the cross-section of the guide post.

In another alternative, a saw assembly adapted for use with a cutting assembly having a slidable saw guide post comprises a nut rigidly attached to the saw assembly, the nut adapted to receive the saw guide post. The saw assembly may comprise a circular saw.

In a further alternative, a cutting table assembly comprises a tube that is hingedly connected to a frame, wherein the tube comprises a longitudinal slot therein. A saw guide post is adapted to be slidably received in the slot, wherein the saw guide post is adapted to be attachable to a saw assembly.

In a still further alternative, a saw guide system comprises a cutting guide tube and a saw assembly. The guide tube assembly comprises a longitudinal slot therein and a saw guide post that is adapted to be slidably received in the slot. The guide tube assembly further comprises a mount in which the tube is positioned, the mount comprising a clamp. A saw assembly comprises a nut rigidly attached to the saw assembly, the nut adapted to receive the saw guide post.

### BRIEF DESCRIPTION OF THE DRAWINGS

FIG. 1 is a perspective view of a saw and cutting table as described herein.

FIG. 2 is a rear perspective view of a saw and a saw guide post and the interaction of those components.

FIG. 3 is a perspective view of a cutting table as described herein.

FIG. 4 is a perspective view of a cutting table and especially a guide tube as described herein.

FIG. 5 is a perspective view of a tube shown in an inclined orientation.

FIG. 6 is a perspective view of a cutting table with the tube rotated to a very open angle.

FIGS. 7-9 are rear elevation, cross-sectional views of alternative embodiments of a guide tube.

FIG. 10 is a perspective view of an alternative embodiment of a saw guide assembly.

### DETAILED DESCRIPTION

The assembly described herein is a mechanically simple saw guide system. In an example of its most basic form, a cutting table has a guide system that releaseably connects with the saw to allow a user to cut a straight line across a work piece, especially wide work pieces like plywood sheets. Structurally, a guide tube is attached to a table. The guide tube has a slot along its longitudinal length. A guide post slides in the slot. The saw includes a nut that fits over the post and is rigidly and slidably supported thereby. Alternatively, the guide tube does not need to be attached to a table. The guide tube may have one or more clamps or other connection devices that secure the guide tube to a work piece or to something relatively stationary that is serving as a work surface.

The following discussion is directed to particular structures including some variations thereof. Of course, those skilled in the art will create further improvements that are also included within the scope of the claims herein.

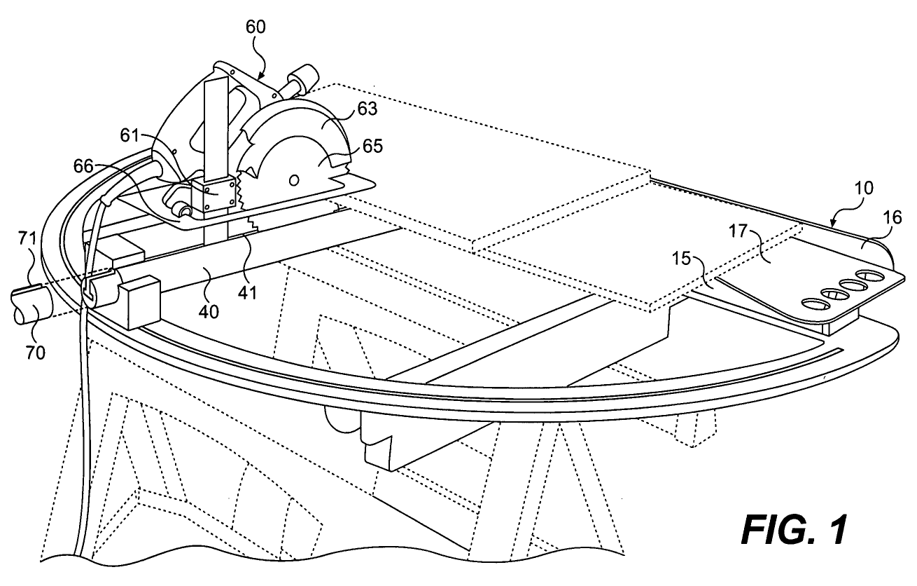

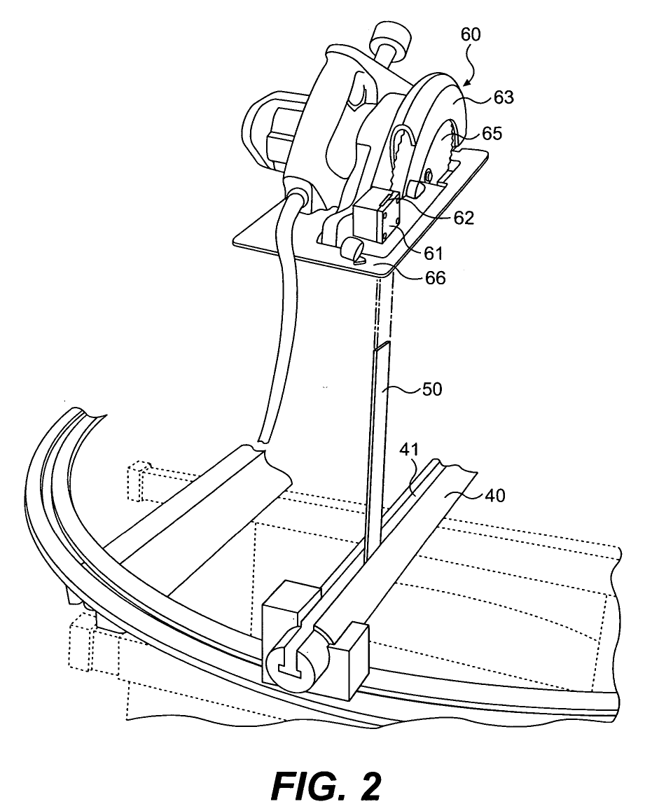

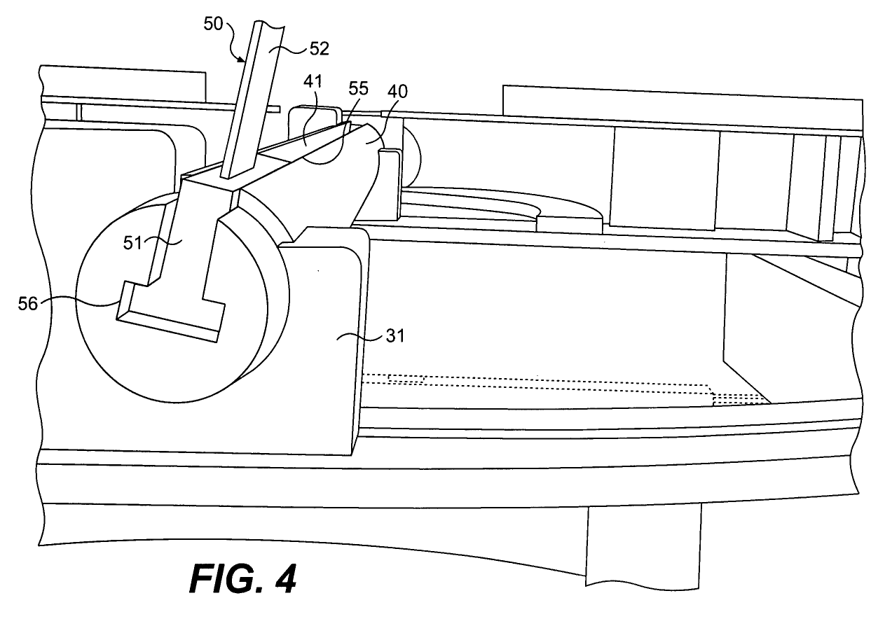

With reference now to FIGS. 1-6, there is shown a cutting table 10. The cutting table 10 is a rigid frame structure made from aluminum or other lightweight metal, wood or plastic material or combination thereof. A cutting table 10 may have telescoping or folding legs that support the table. Alternatively, as shown, the table 10 can be mounted on a sawhorse, or the back of a truck or other stable support surface.

The table 10 is shown in the basic shape of a semi-circle. The straight side 15 includes a vertical fence 16 and flat portion 17. The flat portion 17 defines a planar work surface onto which a work piece (shown in broken lines) may be supported. The center 18 or approximate midpoint of the straight side 15 is the location where a mount 30 is hingedly connected. In operation, the mount 30 is able to rotate substantially 180° so that the tube 40 that is connected to the mount 30 has a range of pivot of substantially 180°. This range of pivot is substantially parallel to the planar work surface. The curved portion 20 of the table 10 is in the form of a semi-circle whose radius is the length from the center 18 of the straight side 15 to the curved portion. The curved portion 20 includes a groove 21 to slideably receive and connect a second mount 31. The table 10 further includes struts 23 and 24 that make the table rigid. The second mount 31 also supports tube 40. The hinged connection of mount 30 and the slidable connection of mount 31 to the straight and curved portions 15 and 20 respectively of the table 10 allow for substantially 180° of rotation of the tube 40. Although not shown in the figures, the curved portion 20 may include markings thereon corresponding to the various angles of the tube with respect to the fence 16 of the table 10.

Mount 31 may further comprise a thumb screw (not shown) or other clamping feature to hold that mount in place along the curved portion 20 once a cut is lined up. The mounts 30 and 31 have flat tops 35 and 36 that provide further support for a work piece. The tops 35 and 36 are generally coplanar with the flat portion 17 of the table 10 to also support a work piece resting on the table.

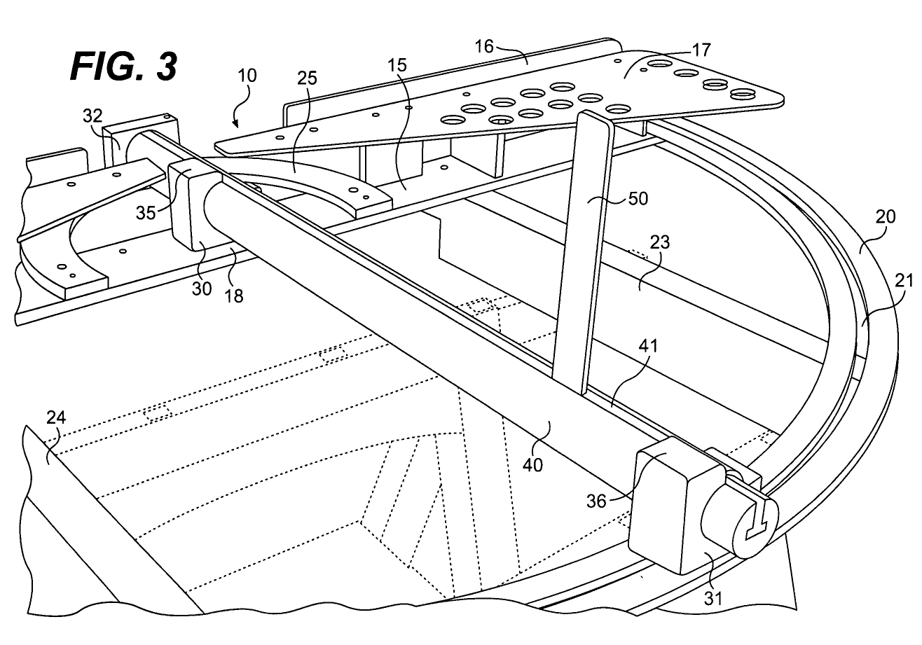

As shown particularly in FIG. 3, a second semi-circle 25 may provide additional support for the tube 40. Mount 32 rests on the semi-circle portion 25 and carries an end of the tube 40. Structurally, this additional mount 32 more rigidly secures the tube 40 and secures the rotation of the tube. Although not shown, the semi-circle portion 25 may also have angle markings identifying angles with respect to the line defined by the fence 16 to indicate angles of cutting.

Tube 40 includes a slot 41 along the longitudinal length thereof and in a straight line. Guide post 50 is slidably received in the slot 41. Guide post 50 is rigidly supported with respect to lateral (side to side) movement while still being slidable in the longitudinal direction. Tube 40 shown in the figures is round so that it may rotate within the mounts 30, 31 and 32. Alternatively, the tube may be other shapes including being square or rectangular in cross section.

Guide post 50 includes a foot portion 51 that is received within slot 41. The foot portion 51 has a cross section that substantially corresponds to the cross section of the slot 41. Of course, in order to be slidable within that slot, the foot portion 51 must have a cross section that is slightly less than the dimensions of the cross section of the slot 41.

Guide post 50 further includes a vertical portion 52 that has a length that extends out of the slot 41. The height/length of the vertical portion 52 is enough that a saw can fit onto it while resting on a work piece over the guide tube 40. In one example, the vertical portion 52 extends several inches out of the slot 41 of the tube 40. Other lengths and even a telescoping arm may alternatively be used. Also, the vertical portion 52 has a thin, rectangular shape. Other shapes may be used to be received with a nut 61. While a vertical portion 52 may have a round cross section, this is not necessarily preferred, because it would allow a saw mounted thereon to rotate.

Guide post 50 is typically made from aluminum or other rigid and strong material. Guide post 50 may be coated, especially around foot portion 51, with a polymer or other coating to enhance slidability. Some of the edges in the foot portion 51 may be rounded or sloped to improve slidability in the slot 41.

The saw 60 has a nut 61 rigidly attached to it. As shown, the nut 61 is fixed to a portion of the body of the saw 60. Nut 61 includes aperture 62 to receive the vertical portion 52 of the guide post 50. The aperture 62 corresponds in shape to the shape of the vertical portion 52. In this case, the aperture 62 is a thin rectangular shape. The nut 61 is mounted on the saw 60 so that the blade 65 is substantially parallel to the guide post 50. In this way, the guide post 50 will move through a cut as the saw cuts through a work piece. As shown, the nut 61 is attached to the safety guard/cover 63 of the saw 60. Alternatively, it could be incorporated as an integral part of that cover 63 or on another part of the saw like the shoe 66.

The nut 61 is not fixed to the guide post 50, although it could be. Preferably, it is slidably engaged only so the saw 60 does not bind during cutting. The vertically slidable engagement allows the saw 60 to move up and down some during use. If desired, a thumbscrew or clamp could fix the nut 61 to the guide post 50.

Tube 40 is shown having a T-shaped slot 41. In practical terms, it is necessary that the slot 41 have a narrow aperture at its edge 55 as compared to the width of a slot further within the tube 40. In the T-shaped example shown, wide portion 56 of the slot 41 is wider than the gap at the edge portion 55 of the slot. In this way, the foot portion 51 is anchored in the slot 41 during the sliding action. As an additional function, the slot 41 acts as a safety notch for the blade 65 of the saw to rotate through so that a user can not inadvertently cut below a work piece.

Also, tube 40 is shown as being a single piece. In order that a user might cut a straight line longer than the length of tube 40, it is seen that extension tubes such as tube 70 may slide on the end of tube 40 so that a user may cut a straight line longer than the width of the cutting table 10. The extension tube 70 has a slot 71 that aligns with the slot 41 so that there is seamless motion through the lengthened slot. Although not shown, the extension tube 70 may include special keys or notches to align the tube slot 71 with the slot 41 in the first tube 40.

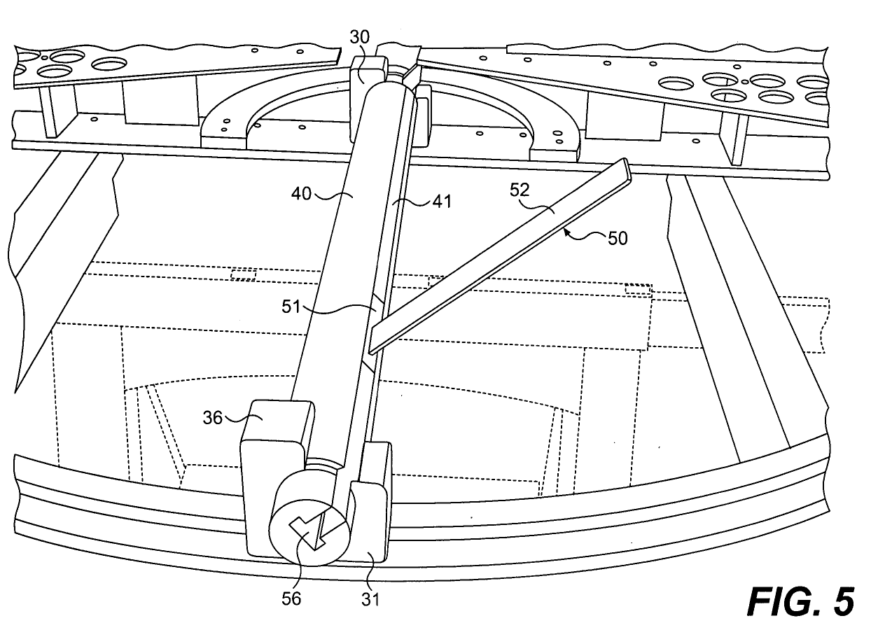

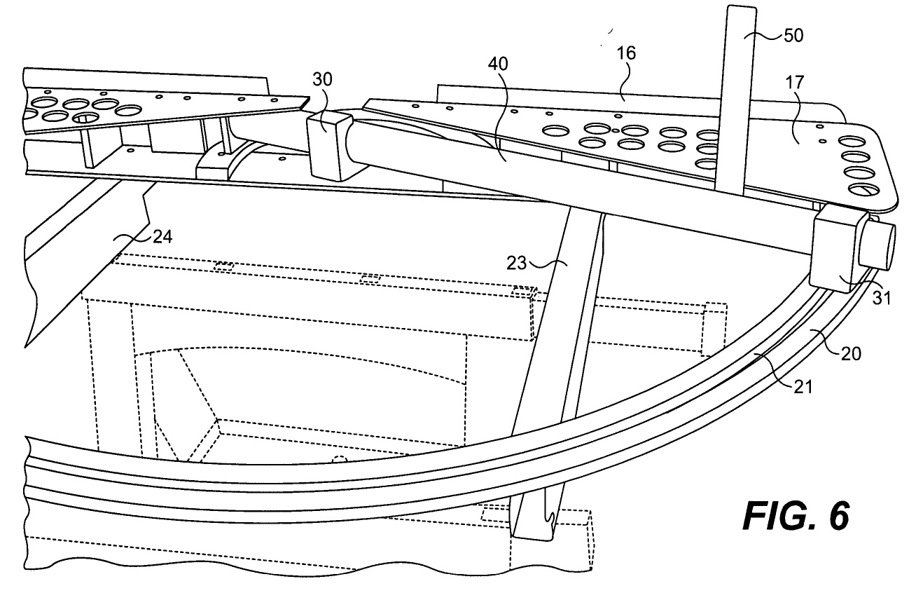

FIGS. 5 and 6 demonstrate two of the flexible variations of the present assembly. In FIG. 5, the guide post 50 is inclined with respect to the plane of the work surface. This incline is obtained by rotation of the guide tube 40 within the mounts 30 and 31. In this way, a beveled cut may be obtained on a work piece. In FIG. 6, the guide tube 40 is shown rotated around with respect to the curved portion 20 such that the angle defined by the fence 16 and guide tube 40 is a very low angle. In this way, very wide or very sharp angles may be trimmed from a work piece.

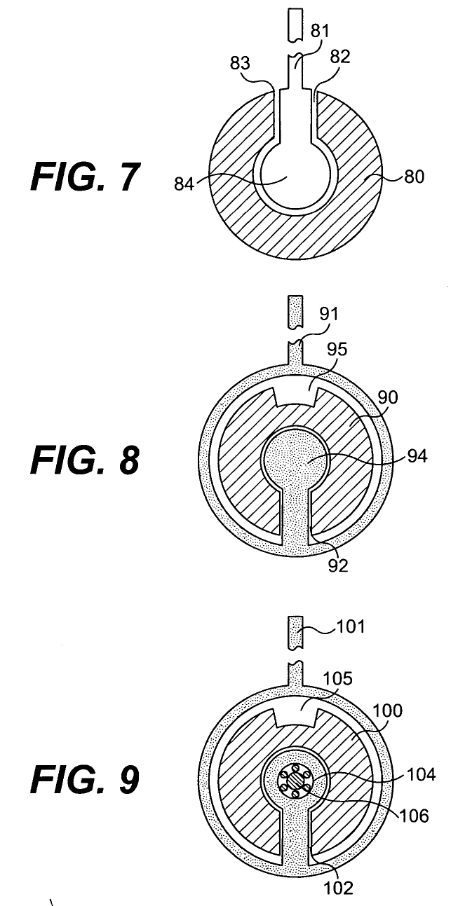

Alternative shapes of slots are shown in FIGS. 7-9. In FIG. 7, the foot portion 84 has a rounded structure. The vertical portion 81 of the guide post extends out directly from the slot 82. As shown, the wider, foot portion 84 of the guide post securely anchors the guide post 81 within the slot 82, because the aperture at the edge 83 of the tube 80 is more narrow than the foot portion 84.

FIGS. 8 and 9 disclose an alternative construction where the guide post 91 or 101 extends away from the tube 90 or 100 on the opposite side of the tube from the slot 92 or 102. In FIG. 8, the post 91 slides with a friction fit. In FIG. 9, there is shown an alternative, ball-bearing construction 106 to enhance the slidability of the guide post 101. By extending the guide post 91 and 101 from the side of the tube 90 and 100 opposite the slot 92 and 102, the slot will not foul as easily with saw dust which could prevent or make more difficult the sliding action of the saw during use. In each case, the tube 90 and 100 includes a safety notch 95 and 105 to receive the saw blade of a saw that is being guided by guide post 91 and 101.

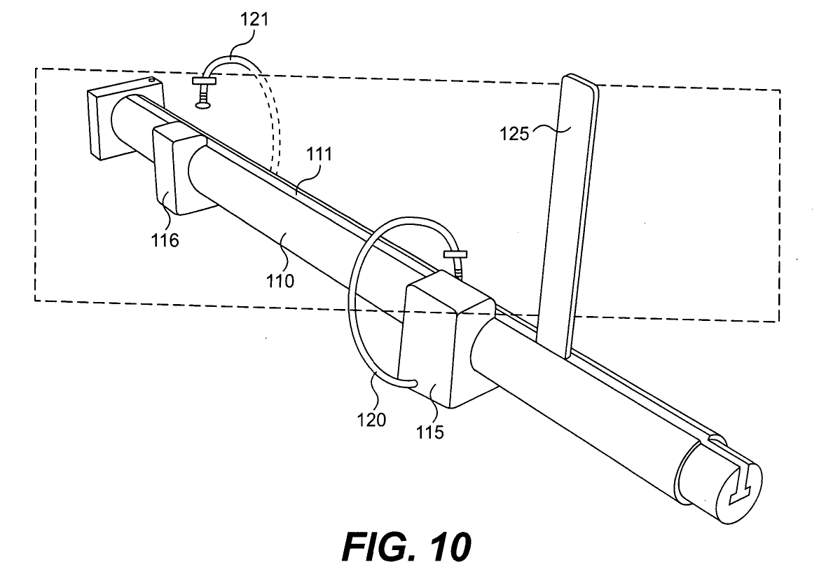

FIG. 10 illustrates an alternative embodiment of a cutting guide tube assembly 110. In this alternative, the guide tube 110 does not need to be mounted onto a table as in the earlier embodiment illustrated in FIGS. 1-6. Instead, the guide tube 110 can simply be mounted onto a work piece or onto another relatively stationary object that is serving as a work surface. In this embodiment in FIG. 10, the guide tube 110 has a longitudinal slot 111 along its length. Mounts 115 and 116 allow the guide tube to rotate around in them. Further, the mounts 115 and 116 are able to be mounted along the length of the tube 110. The mounts 115 and 116 further comprise clamps 120 and 121 respectively. In this way, a work piece may be clamped to the top of the mount 115 and 116. The saw guide post 125 interacts with a saw (not shown) as described earlier. In this way, the simple guide tube assembly 110 may be used to cut a straight line without having a table or other structure necessarily mounted onto it.

While the invention has been described with reference to specific embodiments thereof, it will be understood that numerous variations, modifications and additional embodiments are possible, and all such variations, modifications, and embodiments are to be regarded as being within the spirit and scope of the invention.

1. A saw guide system comprising:
a cutting table assembly and a saw assembly,
the cutting table assembly comprises a tube that is hingedly connected to a frame, wherein the tube comprises a longitudinal slot therein;
the cutting table assembly further comprising a saw guide post that is adapted to be slidably received in the slot; and
the saw assembly comprising a nut rigidly attached to the saw assembly, the nut adapted to receive the saw guide post.

2. A saw guide system as described in claim 1, wherein the saw assembly comprises a circular saw.

3. A saw guide system as described in claim 1, wherein the cutting table defines a substantially planar work surface adapted to support a work piece thereon.

4. A saw guide system as described in claim 3, wherein the tube is hingedly connected on one end to the cutting table, and the tube is adapted to be rotated substantially 180° and substantially parallel to the planar work surface.

5. A saw guide system as described in claim 1, wherein the slot has a T-shaped cross-section.

6. A saw guide system as described in claim 1, wherein the portion of the slot within the tube has a greater cross-sectional width than the width of the slot at the outside edge of the tube.

7. A saw guide system as described in claim 1, wherein the tube has a generally circular outside diameter in cross-section.

8. A saw guide system as described in claim 1, wherein the tube has a generally rectangular outside diameter in cross-section.

9. A saw guide system as described in claim 7, wherein the tube is supported by mounts that movably secure the tube in relation to the table assembly, and that further allow the tube to rotate in place, thereby rotating the orientation of the slot.

10. A saw guide system as described in claim 1, wherein the guide post comprises a foot portion and a vertical portion, wherein the foot portion has a cross-section that substantially corresponds to the cross-section of the slot and the vertical portion has a length that extends out of the slot.

11. A saw guide system as described in claim 10, wherein the vertical portion of the guide post has a rectangular horizontal cross-section and the nut comprises a rectangular aperture substantially corresponding to the cross-section of the guide post.

12. A saw assembly adapted for use with a cutting assembly having a slidable saw guide post, the saw assembly comprising a nut rigidly attached to the saw assembly, the nut adapted to receive the saw guide post.

13. A saw assembly as described in claim 12, wherein the saw assembly comprises a circular saw.

14. A cutting table assembly comprising:
a tube that is hingedly connected to a frame, wherein the tube comprises a longitudinal slot therein, and
a saw guide post that is adapted to be slidably received in the slot, wherein the saw guide post is adapted to be attachable to a saw assembly.

15. A cutting table assembly as described in claim 14, wherein the cutting table defines a substantially planar work surface adapted to support a work piece thereon.

16. A cutting table assembly as described in claim 15, wherein the tube is hingedly connected on one end to the cutting table, and the tube is adapted to be rotated substantially 180° and substantially parallel to the planar work surface.

17. A cutting table assembly as described in claim 14, the slot has a T-shaped cross-section.

18. A cutting table assembly as described in claim 14, wherein the portion of the slot within the tube has a greater cross-sectional width than the width of the slot at the outside edge of the tube.

19. A cutting table assembly as described in claim 14, wherein the tube has a generally circular outside diameter in cross-section.

20. A cutting table assembly as described in claim 14, wherein the tube has a generally rectangular outside diameter in cross-section.

21. A cutting table assembly as described in claim 19, wherein the tube is supported by mounts that movably secure the tube in relation to the table assembly, and that further allow the tube to rotate in place, thereby rotating the orientation of the slot.

22. A cutting table assembly as described in claim 14, wherein the guide post comprises a foot portion and a vertical portion, wherein the foot portion has a cross-section that substantially corresponds to the cross-section of the slot and the vertical portion has a length that extends out of the slot.

23. A saw guide system comprising:
a guide tube assembly and a saw assembly,
wherein the guide tube assembly comprises a longitudinal slot therein and a saw guide post that is adapted to be slidably received in the slot;
the guide tube assembly further comprising a mount in which the tube is positioned, the mount comprising a clamp; and
the saw assembly comprising a nut rigidly attached to the saw assembly, the nut adapted to receive the saw guide post.
